(19) United States
(12) Patent Application Publication
(10) Pub. No.: US 2013/0041641 A1
(43) Pub. Date: Feb. 14, 2013

(54) METHOD FOR IDENTIFYING FRICTION IN A HINGE OF A ROBOT ARM OR MANIPULATOR ARM, AND USE THEREOF IN A TORQUE COMPENSATION METHOD

(71) Applicant: Philippe Garrec, Gif Sur Yvette (FR)

(72) Inventor: Philippe Garrec, Gif Sur Yvette (FR)

(73) Assignee: COMMISSARIAT A L'ENERGIE ATOMIQUE AUE ERERGIES ALTERNATIVES, PARIS (FR)

(21) Appl. No.: 13/642,731

(22) PCT Filed: Mar. 27, 2011
(86) PCT No.: PCT/EP11/58746

§ 371 Date: Oct. 22, 2012

(30) Foreign Application Priority Data
Jun. 2, 2010 (FR) 10 02347

(51) Int. Cl. G06F 17/10

(52) U.S. Cl. 703/2

(57) ABSTRACT

An identification method for identifying the behavior of a hinge of a robot arm or of a manipulator arm, the method including the steps of selecting a behavior model linking the input torque and the output torque of the hinge depending on operating parameters, and of operating the hinge in such a manner as to measure several (input torque/output torque) operating points, and of performing a regression in order to identify the parameters of the model and thus to determine at least one of the direct or indirect characteristics of the hinge. The behavior model retained includes dry friction having a first component that does not depend on the output torque, and a second component that does depend on the output torque of the hinge.

The invention relates to a method of identifying friction in a hinge of a robot arm or a manipulator arm, and to a torque compensation method making use thereof. By way of example, the invention is useful for detecting interaction of the manipulator arm with its environment (contact, human intervention) independently of its load, or for enabling the manipulator arm to be moved manually with resistance that is independent of the direction of movement and of the load (remote operation, cobotics).

### TECHNOLOGICAL BACKGROUND OF THE INVENTION

In a remote operation system using mechanically reversible master and slave manipulators, it is known to use the motor to compensate for the effect of gravity on the portion of arm downstream of the hinge. To this end, the motor is controlled in order to develop torque that compensates gravity torque. When compensated in this way, the hinge is easier to manipulate and, in particular, in order to cause the hinge to move in one direction or the other it is sufficient for the operator to exert torque on the hinge that is equal only to the friction torque.

It is known to establish a behavior model for such a hinge by assuming that there is dry friction (or Coulomb friction) that remains constant, and therefore independent of the load.

The prior art is described with reference to FIG. 1, which shows a transfer diagram of a reversible mechanism (abscissa: input torque; ordinate: output torque) where the characteristics, assuming constant dry friction, are parallel straight lines that are offset symmetrically relative to the origin. The friction corresponds implicitly to the difference between one of the characteristics and a parallel reduction ratio straight line that passes through the origin. The dotted straight lines correspond to the force required for starting movement for each direction of applied force (the so-called “static” friction coefficient) and the continuous straight lines correspond to the equilibrium force at low speed (the so-called “dynamic” friction coefficient).

When the energy is transmitted from the input (driving motor) to the output (resisting load), the characteristic is said to be forward or “direct” and when the opposite is true it is said to be reverse or “indirect”. In order to explain these ideas more clearly, the direct characteristic corresponds for example to raising the arm in opposition to its own weight and to the weight of the load, whereas the indirect characteristic represents lowering of the arm. For that reason each straight line is divided into two segments that are separated by a pivot point situated in the dissipative quadrant. There are therefore a total of four straight line segments in dotted lines and four straight line segments in continuous lines.

The diagram should be read as follows: for a given input torque C1e, an output torque of C1s is obtained while operating in the direct direction (e.g. while raising the arm segment connected to the hinge), and an output torque C1s′ is obtained while operating in the indirect direction (e.g. while lowering the arm segment connected to the hinge). Conversely, for a given output torque C2s, it is necessary to develop a torque C2e for operating in the direct direction, and to develop a torque C2e′ for operating in the indirect direction.

However, compensation based on the model of FIG. 1 does not give satisfaction in practice. In use, a certain amount of asymmetry can be felt that increases with load that depends on whether the hinge is operating in the direct or the indirect direction, which can be problematic for operator “feel”.

### OBJECT OF THE INVENTION

The invention relates to a method of identifying a model giving a more accurate account of the behavior of the hinge and its use in order firstly to improve compensation by controlling gravity torque, and secondly to improve detection of interaction between the robot and the outside.

### BRIEF DESCRIPTION OF THE INVENTION

To this end, there is provided an identification method for identifying the behavior of a hinge of a robot arm or of a manipulator arm, the method comprising the steps of selecting a behavior model linking the input torque and the output torque of the hinge depending on operating parameters, and of operating the hinge in such a manner as to measure several (input torque/output torque) operating points, and of performing a regression in order to identify the parameters of the model and thus to determine at least one of the direct or indirect characteristics of the hinge, and wherein, according to the invention, the behavior model retained includes dry friction having a first component that does not depend on the output torque, and a second component that does depend on the output torque of the hinge.

Thus, the identification enables friction characteristics to be established in an input torque/output torque diagram that are no longer necessarily parallel, but that have two slopes, or that are biconical.

This can be explained by the fact that when the efficiencies differ from unity, the model shown in FIG. 1 no longer conforms to the Coulomb theory that predicts that dry friction depends on the intensity of the contact reaction between the parts in movement and starting from the transmitted load (conventional concept of efficiency as given in mechanics textbooks). However, in industrial manipulators for example, said efficiency is frequently very different from unity and as a result the above-described compensation is correspondingly increasingly faulty with increasing load. Consequently, and by way of example, a contact force may be incorrectly evaluated and when used in remote operation, or in cobotics (so-called “transparent” mode), the movement force will not only be asymmetrical in the two directions but it will also depend on the load being supported by the manipulator.

This leads to an appearance that is no longer parallel to the direct and indirect characteristics but rather that is biconical. The adoption of a biconical model also modifies how inertia forces are evaluated and therefore how the parameters of the dynamic model are evaluated. The inertial terms of the conventional dynamic model are weighted by the corresponding direct or indirect efficiency. Contrary to the model in FIG. 1, the parameters are therefore increasingly erroneous with efficiencies that are smaller.

In a particular aspect of the invention, the dry friction is further made to depend on a parameter representative of the speed of movement of the hinge. Preferably, at least one of the dry friction components includes a constant portion and a portion depending on an exponential relaxation term that is a function of the speed parameter

This improved model is more particularly suitable when the efficiency of the drive train improves as the speed increases. This phenomenon is observed in particular with oil-lubricated reduction gearing having low efficiency at the low speeds used specifically for remotely-operated manipulations. In the above-described diagram, the increase in speed is shown by the characteristics being spaced apart. The increase in efficiency with increasing speed is therefore shown by the spacing apart and the straightening of the slope of the characteristics.

In the invention, advantage is taken of this new model to implement compensations in the hinge. In particular, there is provided a method of controlling a hinge of a manipulator arm that is capable of operating in the direct direction and in the indirect direction, the compensation method comprising the steps of:
identifying direct and indirect operating characteristics of the hinge in an input torque/output torque plane, by using the dry friction model of the invention; and
exerting a compensation torque on the hinge in such a manner as to position the equilibrium point of the hinge in the vicinity of a median of the direct and indirect characteristics of the hinge as determined in this way.

The taking into account of direct and indirect efficiencies in order to establish the operating characteristics, which give rise to distinct slope characteristics, and choosing to position the equilibrium point not on a parallel passing through the origin but rather on a median of the characteristics leads to compensation that is better at reducing the above-mentioned asymmetrical effects, and that leads to operation of the hinge that is more transparent for the user.

### BRIEF DESCRIPTION OF THE FIGURES

The invention can be better understood in the light of the following description made with reference to the accompanying figures, in which:

FIG. 2 shows the direct and indirect characteristics of a hinge when distinct direct and indirect efficiencies are taken into account;

FIG. 3 shows the compensation principle of the invention, consisting in positioning the equilibrium point onto the median of the real characteristics; and

FIG. 4 shows the principle of friction compensation in a particular implementation of the invention.

### DESCRIPTION OF THE FIGURES

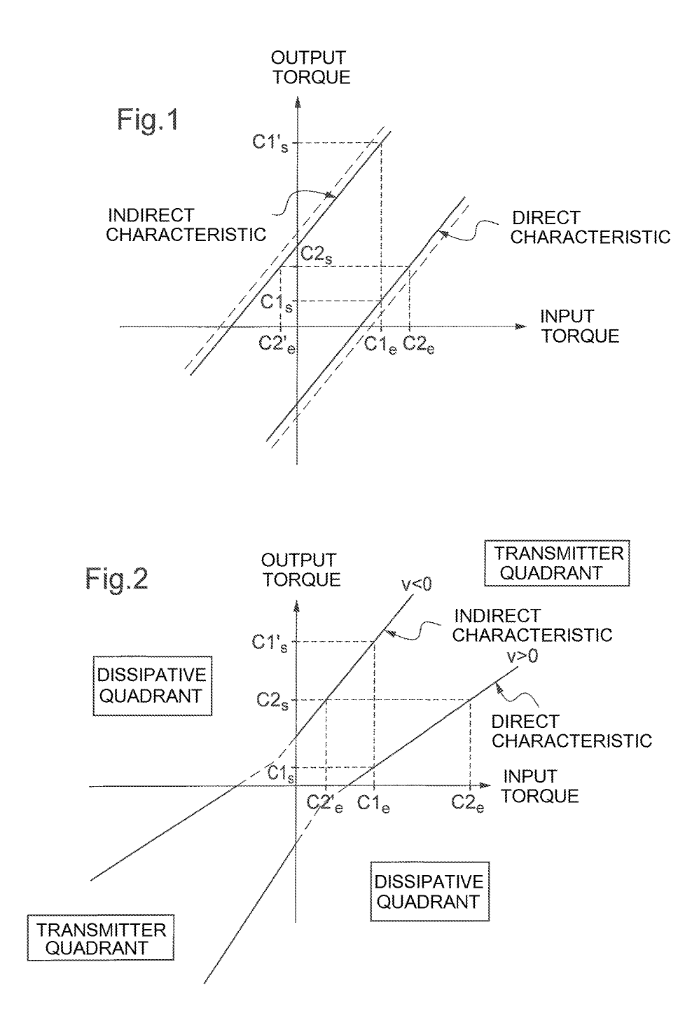

The invention is based on selecting a friction model as shown in FIG. 2 in which the operating characteristics of the hinge are no longer parallel. The slope of the direct characteristic is proportional to the efficiency of the hinge when it operates in the direct direction, and the slope of the indirect characteristic is proportional to the efficiency of the hinge when it operates in the indirect direction, both slopes then being distinct since the direct efficiency and indirect efficiency are distinct.

In addition, the characteristics change slope when moving from the first quadrant to the third quadrant of the diagram. A friction zone is thus obtained that is no longer in the shape of a strip, but rather in the shape of a throat or constriction (by convention, the connections between half-characteristics are defined by extending the characteristics into the dissipative quadrants).

This diagram should naturally be read in the same way as FIG. 1. For a given input torque C1e, an output torque of C1s is obtained while operating in the direct direction (e.g. while raising the arm segment connected to the hinge), and an output torque C1s′ is obtained while operating in the indirect direction (e.g. while lowering the arm segment connected to the hinge). Conversely, for a given output torque C2s, it is necessary to develop a torque C2e for operating in the direct direction, and to develop a torque C2e′ for operating in the indirect direction.

More precisely, the model used for the identification that leads to these characteristics makes the dry friction depend on the load to which the hinge is subjected (and thus on its output torque). Thus, in addition to having a constant component, the dry friction has added thereto a component that depends on the absolute value of the load, e.g. that is proportional thereto. If Cs is the load to which the hinge is subjected, then the dry friction can be written:

Fc=(β+α|Cs|)·sign(\dot{q})

where α is a coefficient of proportionality, β is the constant component, and \dot{q} is a parameter of the speed of movement of the hinge, e.g. the speed of rotation of the hinge. Thus, the dry friction now includes a first component that depends on the output load, specifically in this example, in proportional manner.

It should be noted that the component of the dry friction that varies with the load can be written:

α|Cs|·sign(\dot{q})=α·Cs·sign(Cs)·sign(\dot{q})=α·Cs·sign(Ps)

where Ps=Cs·\dot{q} is the outlet power.

In an even more precise version of the model of the invention that is particularly adapted to operating the hinge at low speed, the dry friction is made to depend on the speed of movement of the hinge, preferably obeying the following relationship:

Fc=((a+b·e^{-|\dot{q}|/v})|Cs|+(c+d·e^{-|\dot{q}|/v}))·sign(\dot{q})

where a, b, c, d are constant coefficients and v is a speed constant.

This friction model, which is valid for a non-zero speed, is incorporated in a Stribeck friction model that takes account of adherence friction at zero speed.

Provided with such a model, and in accordance with known identification methods, it therefore suffices to operate the hinge and to measure input and output torque for various operating points, both in direct operation and in indirect operation. Regression can then be used to identify the coefficients used in the model, leading to the characteristics shown in FIG. 2. Naturally, these characteristics correspond to a given speed. The greater the speed used, the farther the characteristics are spaced apart and the straighter they become.

These characteristics conform more closely to the real behavior of the hinge, and make it possible to provide more effective compensation. Such a hinge is generally fitted with a motor, one of the functions of which is to compensate the torque due to the weight of the downstream arm portion, or gravity torque. The compensation torque of the motor C_{comp} is adjusted in such a manner that, in the absence of any external stress, the arm remains in equilibrium inside the friction strip extending between the two characteristics, so that it is stable and does not move under the effect of gravity. To this end, the motor torque is generally adjusted so that it is equal to the gravity torque divided by the reduction ratio of the gearbox coupled to the motor.

Naturally, the value of the compensation depends on the weight of the load carried by the arm, as well as on the position of the arm in three-dimensional space. It is advisable to modify the compensation torque in real time so that the gravity torque is opposed in appropriate manner at all times.

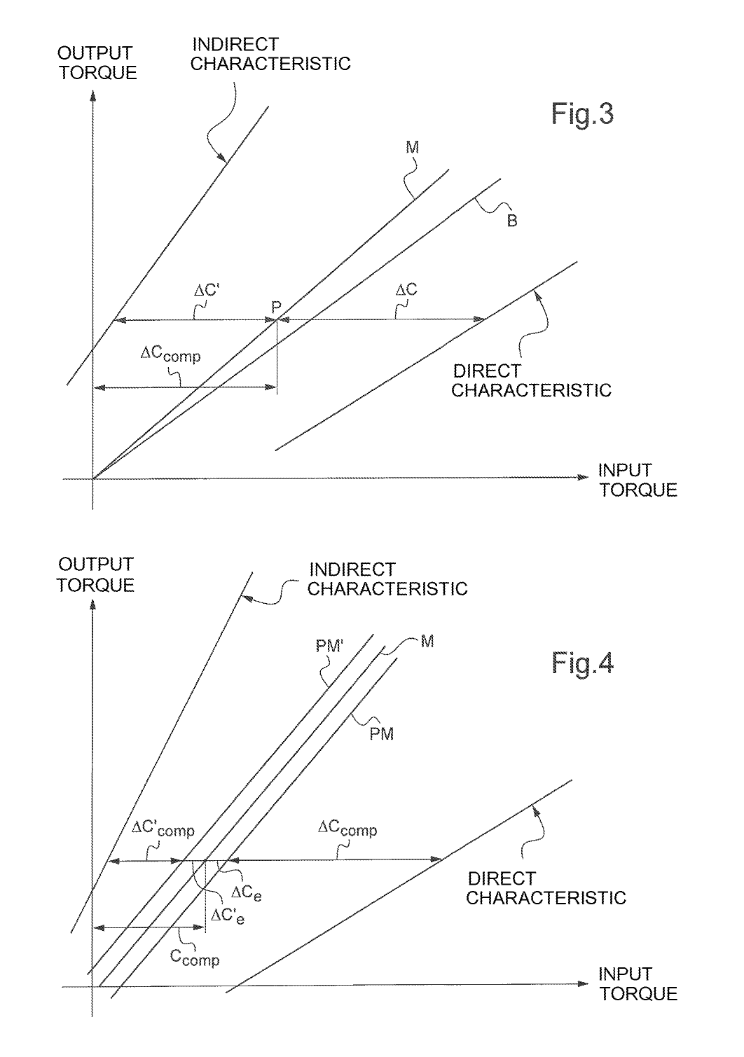

FIG. 3 shows the effect of the compensation of the invention. In this embodiment it is chosen to position the operating point of the hinge on the median M of the two characteristics, which median is the locus of the equilibrium points P, i.e. the locus of the points at equal distance from both characteristics, the distance being taken parallel to the input torque axis. The compensation torque C_{comp} exerted by the motor is taken between the vertical axis and the point P. Thus, for a given outlet torque Cs, it is necessary to develop a torque that is equal to the increment ΔCe for operation in the direct direction, and a torque equal to the increment ΔCe′ in the indirect direction (these two torques being opposite), the two increments then being taken from an equilibrium point P situated on the median M. It should be observed that choosing to compensate along the median leads to increments in torque that are equal in absolute value, which makes operation of the hinge symmetrical. The situation would be different, if, in accordance with the first reaction of the person skilled in the art, the operating point were to be positioned not on the median, but on the bisector B of the two characteristics.

It should be noted that the median in question is the median along the ordinate axis, i.e. the median that is constructed by taking, on each line parallel to the ordinate axis, the mid-point between the intersections of said line with the direct and indirect characteristics.

The above-described compensation is preferably a permanent compensation, which is also active when the arm is not being manipulated or stressed externally.

In practice, this compensation could be adjusted by a simple procedure. Using a given compensation torque, the torque is measured that is needed to make the hinge move in one direction and in the other. If these torques are different, the compensation torque is modified in the appropriate direction and by adding or subtracting half of the difference between the two measured torques. This continues until the differences between the two measured torques are identical to each other within a given margin of error. During this procedure of adjusting the compensation, the movement of the arms about the hinge is driven by the motor that generates the torque necessary for making the hinge move in one direction and in the other. Naturally, it is advisable to repeat this adjustment procedure regularly in order to guarantee that the arm is compensated in all circumstances. In particular, the compensation adjustment procedure could be triggered on each occasion that, in the absence of external stress, the arm starts to move under the effect of compensation torque developed by the motor.

While remaining within the ambit of the invention, additional compensation ΔC_{comp} may be added to said permanent compensation C_{comp}, which additional compensation ΔC_{comp} makes it possible to compensate at least in part the friction of the hinge when the operator is applying stress to the hinge. To this end, the sign of the speed of movement induced by the action of the operator may be observed, and by means of the motor at least a portion of the opposing friction torque that opposes the movement generated by the action of the operator is compensated. In practice, it is advisable to avoid compensating friction completely, in order to leave a friction zone around the median M so as to ensure absolute stability of the hinge around the compensated equilibrium point.

The result of this additional compensation can be seen in FIG. 4. As soon as the setting into movement and the direction of that moment have been observed, the motor, in addition to the compensation torque, exerts an additional compensation torque equal to the torque ΔC_{comp} (or ΔC_{comp}′ as the case may be) taken between the characteristic under consideration and a characteristic parallel to the median M (straight lines PM and PM′, respectively), in such a manner that the torque needed to move the hinge is thus reduced to a torque ΔCe (or ΔCe′ as the case may be) taken between the median and the corresponding parallel line.

Thus, the user has the impression of manipulating a hinge with a very small friction dead zone. However, it is advantageous not to eliminate this dead zone entirely, in order to leave a zone of absolute stability in which the hinge remains at rest in the absence of external stress.

The invention is not limited to the description given above, but on the contrary it encompasses any variant coming within the ambit defined by the claims. In particular, although in this embodiment the disturbing torque that is compensated is the weight of the portion of the manipulator arm downstream from the hinge, other disturbing torques could naturally be compensated. In addition, if the hinge is fitted with a torque compensation member (e.g. a spring), it is then advisable to take said member into account in the compensation. In addition, although in this embodiment the hinge is reversible (its characteristics have positive slopes), the above description also applies to an irreversible hinge for which the slope of the indirect characteristic is negative and that could be fitted with a force sensor at its output. Under such circumstances, the action of the motor controller can be made symmetrical by selecting a median calculated along the input (abscissa axis), or at the very least in the vicinity thereof.

1. An identification method for identifying the behavior of a hinge of a robot arm or of a manipulator arm, the method comprising the steps of selecting a behavior model linking the input torque and the output torque of the hinge depending on operating parameters, and of operating the hinge in such a manner as to measure several (input torque/output torque) operating points, and of performing a regression in order to identify the parameters of the model and thus to determine at least one of the direct or indirect characteristics of the hinge, wherein the behavior model retained includes dry friction having a first component that does not depend on the output torque, and a second component that does depend on the output torque of the hinge.

2. An identification method according to claim 1, wherein the dry friction is further made to depend on a parameter representative of the speed of movement of the hinge.

3. An identification method according to claim 2, wherein at least one of the dry friction components includes a constant portion and a portion depending exponentially on the speed parameter.

4. A method of compensating disturbing torque exerted on a hinge of a manipulator arm being able to operate in the direct direction and in the indirect direction, the compensation method comprising the steps of:
implementing the identification method according to claim 1 in order to identify the direct and indirect characteristics of the hinge; and
exerting a compensation torque (C_{comp}) on the hinge in such a manner as to position the equilibrium point of the hinge in the vicinity of a median of the ordinate of the direct and indirect characteristics of the hinge as determined in this way.

5. A method according to claim 4, wherein the compensation torque is exerted by a motor fitted on the hinge.

6. A method according to claim 4, wherein in addition to the compensation torque, an additional compensation torque is exerted on the hinge in order to compensate the friction in the hinge at least in part.
